(19) United States
(12) Patent Application Publication
(10) Pub. No.: US 2007/0222225 A1
(43) Pub. Date: Sep. 27, 2007

(54) Horizontal Wind Turbine

(76) Inventor: Patrick Mahoney, Christiansted, VI (US)

Correspondence Address: HOFFMANN & BARON, LLP, 6900 JERICHO TURNPIKE, SYOSSET, NY, 11791, US

(21) Appl. No.: 11/690,392

(22) Filed: Mar. 23, 2007

Related U.S. Application Data
(60) Provisional application No. 60/785,069, filed on Mar. 23, 2006.

(51) Int. Cl. F03D 9/00; H02P 9/04

(52) U.S. Cl. 290/55

(57) ABSTRACT

The present invention is directed to a system and method for collecting energy from a prevailing wind. The system and method include a concentrating structure having a surface substantially facing an unobstructed expanse of a terrain and/or water communicating the prevailing wind toward the surface. The surface is configured to deflect and concentrate the prevailing wind. Also, the system includes a wind turbine having a rotational axis substantially horizontal and perpendicular to the direction of the prevailing wind. The wind turbine is mounted adjacent to the structure and situated to receive the concentrated wind.

### CROSS-REFERENCE TO RELATED APPLICATIONS

This application claims the benefit of U.S. Provisional Patent Application Ser. No. 60/785,069 filed on Mar. 23, 2006.

### BACKGROUND OF THE INVENTION

The present invention relates to a wind turbine, and more particularly to a wind collection apparatus with a rotor axis oriented both horizontal and perpendicular to the direction of the prevailing wind, taking advantage of natural and/or manmade wind deflection structures for concentrating the wind energy forces.

Wind power is a known source of energy and has been harnessed in various fashions. Today, wind turbines are generally broken down into two basic configurations, namely vertical axis wind turbines (VAWTs) and horizontal axis wind turbines (HAWTs).

VAWTs are generally designed in two different configurations, lift-based and drag-based designs. In both designs, a vertical shaft supported at its base holds the wind collection device. The drag base design works like a paddle used to move a canoe through the water. In this configuration, the maximum speed for the wind collection device would be approximately the same speed as the wind. This would be analogous to saying that the maximum speed of a rowboat would be the speed the paddles are dragged through the water. The same principal applies to a wind turbine. Where the maximum speed of the wind collection elements of a wind turbine approximate the prevailing wind, the assembly is said to operate with a tip-speed ratio (TSR) of one. Drag-based designs tend to have a TSR of approximately one. Although some VAWTs are known to slightly exceed TSR of one, they do not generally do so by very much. These devices are not generally favored for generating electricity due to this relatively low TSR design. Additionally, the single vertical axis design of a VAWT generally requires guide cables from the top of the structure which impose large thrust loading on the main turbine bearings which further reduce efficiencies and have their own set of problems.

Lift-based VAWTs are also referred to as having an “egg beater” design. This design generates a maximum lift (torque) on a predetermined number of revolutions (usually two revolutions) making for a higher sinusoidal output analogous to a cyclist cranking on bicycle pedals. However, VAWT blades have naturally frequencies of vibration which must be avoided during operation. This phenomenon is not present in most HAWT designs. Additionally, as with the drag-based VAWTs, the vertical axis design generally experiences large thrust loading on the main turbine bearings which makes this design less desirable.

Today, commercial wind turbines are almost exclusively HAWTs whose axis is generally maintained parallel to the prevailing winds. These HAWTs generally use airfoil shaped blades which in effect use a lift-type configuration to move the turbine blades. The wind thus passes over both upper and lower surfaces of each airfoil shaped blade creating a lift vector due to the differential pressure between the top and bottom surfaces of the blade. These are the same forces generally used in the aviation industry to lift an aircraft off the ground. This type of wind turbine claims very high efficiency though it is burdened with some disadvantages. In particular, the minimum operational wind speed they require is relatively high, while the maximum wind speed they can endure tends to be relatively low, thus allowing for only a limited operational window. Beyond that operational window the device is prone to damage and must not be allowed to operate. For example, these devices could not take advantage of gale or hurricane force winds, and would have to be shut-down under such conditions or suffer damage. Additionally, in order to minimize the turbulent air flow effects that occur near the ground or man-made structures, these devices are generally mounted on tall towers which make service and replacement of parts very difficult. Further, due to their high profile design, these HAWTs can have problems associated with migratory birds. Also their aesthetic impact on the landscape is often objected to by the general public.

Another HAWT design has a horizontal turbine axis perpendicular to the direction of the prevailing wind is commonly known as a wind wheel. The turbine axis in this design can be supported at two positions (normally the ends) and thus can withstand high wind speeds. However, like the design parameters of the drag-based VAWT, this design is generally limited to a TSR of one. Thus, the device does not generally turn faster than the prevailing wind. As a TSR one design is generally disfavored by the energy industry, such wind wheels are not used in modern applications.

Thus, it is desirable to provide a system and method of collecting energy from a prevailing wind and/or a source of energy produced by such systems/methods that overcome the shortcomings described above. In particular, it is desirable to provide a wind collection system that can produce wind turbine tip speeds higher than that of the regional prevailing winds. Also, a sturdy design is preferred that can tolerate high wind speeds, turbulence and not be prone to destructive natural frequencies. Further, it is desirable to provide a system with a low profile mounting that is aesthetically pleasing and less obstructive to birds.

### SUMMARY OF THE INVENTION

The present invention, which addresses the needs of the prior art relates to a wind collection system that utilizes a rotor whose axis is oriented both horizontally and perpendicular to the direction of the prevailing wind and takes advantage of the increasing wind forces that can be generated by natural topographical and/or man-made wind deflection surfaces.

One aspect of the present invention is directed to a wind energy collection system comprising a wind turbine having a rotational axis both horizontal and perpendicular to a prevailing wind direction, the wind turbine mounted at or near the top edge of a down-sloping structure, the structure adapted to deflect and concentrate the prevailing wind toward the wind turbine, and the structure located adjacent an unobstructed expanse communicating the prevailing wind toward at least one of the structure and the wind turbine. The structure can comprise at least one of an artificial construct and a natural geographic feature. The wind energy collection system can further comprise at least one horizontal wind deflector mounted up wind and laterally to the wind turbine relative to the prevailing wind, the horizontal wind deflector adapted to further deflect and concentrate the prevailing wind toward the wind turbine.

Another aspect of the present invention is a system for collecting energy from a prevailing wind. The system includes a concentrating structure having a surface substantially facing an unobstructed expanse of a terrain and/or water communicating the prevailing wind toward the surface. The surface is configured to deflect and concentrate the prevailing wind. Also, the system includes a wind turbine having a rotational axis substantially horizontal and perpendicular to the direction of the prevailing wind. The wind turbine is mounted adjacent to the structure and situated to receive the concentrated wind.

Additionally, the structure can include at least one of an artificial construct and a natural geographic feature. The structure can be sized to be significantly larger than the wind turbine and/or larger than the wind turbine by at least one order of magnitude. Also, the structure can include at least one of a bluff, cliff, knoll, hill or man-made building. The wind turbine can be structurally supported on two lateral sides relative generally to the prevailing wind. Also, the wind turbine rotational axis can terminate substantially at both lateral sides. Further, the structural supported on two lateral sides relative generally to the prevailing wind. Also, the wind turbine rotational axis can terminate substantially at both lateral sides. Further, the structural support can cooperate to maintain the wind turbine collecting energy during gale or higher force winds. Also, the rotational axis of the wind turbine can be positioned perpendicular to the concentrated wind. Additionally, the system can include an electrical power storage sub-system and transmission cables communicating electrical power between the wind turbine and the storage sub-system. Further, the system can include at least one horizontal wind deflector mounted up-wind and laterally to the wind turbine relative to the prevailing wind. The horizontal wind deflector can further deflect and concentrate the prevailing wind toward the wind turbine.

Yet another aspect of the present invention is a system for converting wind energy including a wind wheel with a rotational axis extending laterally relative to a prevailing wind, the wind wheel mounted at or near the top of a building, the building including at least one vertical surface adapted to direct a portion of the prevailing wind toward the wind wheel, the wind wheel disposed to be driven by the directed portion of the prevailing wind and thereby converting wind energy.

Another aspect of the present invention is a method of collecting wind energy comprising providing a wind turbine having a rotational axis disposed both horizontal and perpendicular to horizontal prevailing wind, mounting the wind turbine in a coastal region on a preferred wind collection location, the location including an elevated land formation adjacent a steeply down-sloping decline exposed to the prevailing winds, the decline disposed to redirect the prevailing winds upward to the wind turbine.

Yet another aspect of the present invention is a method of collecting wind energy. The method includes locating a wind turbine adjacent the top edge of a structural formation. The formation includes a surface extending downward from the top edge and substantially facing an unobstructed expanse of at least one of a terrain and water communicating a prevailing wind. The surface is configured to redirect and concentrate the prevailing wind upward toward at least the top edge of the formation. The method also includes positioning the wind turbine to have a rotational axis disposed substantially horizontal and perpendicular to the prevailing wind and disposed to receive the concentrated wind.

Additionally, the method can include positioning at least one horizontal wind deflector up-wind and laterally to the wind turbine relative to the prevailing wind. The horizontal wind deflector can further deflect and further concentrate at least one of the prevailing wind and the concentrated wind toward the wind turbine. The method can further include coupling an electrical power storage sub-system to the wind turbine for collection and/or redistribution of power between the wind turbine and the storage sub-system. The wind turbine can be structurally supported on two lateral sides relative generally to the prevailing wind. Also, the wind turbine rotational axis can terminate substantially at both lateral sides. The rotational axis of the wind turbine can be positioned perpendicular to the concentrated wind.

Yet another aspect of the present invention is a source of electrical energy produced by a process. The process includes locating a wind turbine adjacent the top edge of a structural formation. The formation includes a surface extending downward from the top edge and substantially facing an unobstructed expanse of at least one of a terrain and water communicating a prevailing wind. The surface is configured to redirect and concentrate the prevailing wind upward toward at least the top edge of the formation. The process also includes positioning the wind turbine to have a rotational axis disposed substantially horizontal and perpendicular to the prevailing wind and disposed to receive the concentrated wind.

Additionally, the source of electrical energy can be produced by a process further including positioning at least one horizontal wind deflector up-wind and laterally to the wind turbine relative to the prevailing wind. The horizontal wind deflector can further deflect and concentrate the prevailing wind and/or the concentrated wind toward the wind turbine. Also, the process can include coupling an electrical power storage sub-system to the wind turbine for collecting and/or redistributing power between the wind turbine and the storage sub-system. Further, the structural formation can include at least one of an artificial construct and a natural geographic feature. Also, the wind turbine can be configured to collect wind energy during gale or higher force winds.

### BRIEF DESCRIPTION OF THE DRAWINGS

FIG. 1 is a conceptual drawing of an elevation view illustrating the concentrating effect that a sloped obstruction has on the prevailing wind generating higher than ambient wind velocities.

FIG. 2 is a conceptual drawing of a plan view illustrating the concentrating effect of vertical obstructions used to channel airflow into a wind turbine.

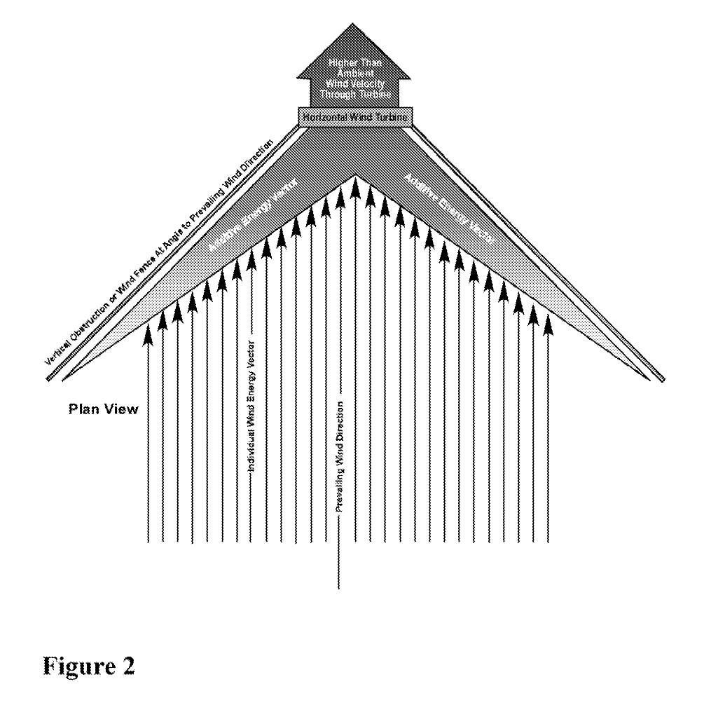

### DESCRIPTION OF THE PREFERRED EMBODIMENT

With reference to the drawings, a new and improved wind collection system embodying the principles and concepts of the present invention will be described.

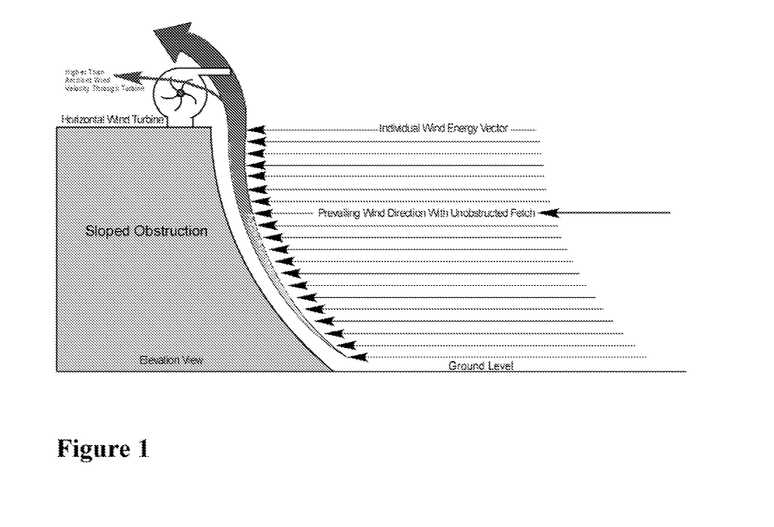

As shown in FIG. 1, the present invention takes advantage of the multiplication of wind energy vector forces that result when a horizontal flow of wind over an unobstructed course encounters a steep sloping obstacle, such as a natural cliff face or man-made structure. In such an instance, the wind vectors below the crest of the obstruction are generally deflected upward along the face of the obstruction. As these wind or energy vectors are deflected upward, their energy is concentrated resulting in an increase in velocity and therefore total energy. However, these high velocity winds are also generally associated with higher turbulence levels. This combination of high winds and high turbulence levels is not suitable to the contemporary horizontal axis wind turbine (HAWT) designs that have a rotational axis parallel to the prevailing wind. Nor are such conditions suitable for vertical axis wind turbine (VAWT) designs. Thus, in accordance with the preferred embodiment of the present invention an HAWT with a rotational axis perpendicular to the prevailing winds (a “wind wheel design”) is employed to take advantage of these increased wind vector conditions.

A wind wheel energy collection system can compensate for the high structural stresses imparted by high velocity or turbulent wind conditions. With structural supports at or near two lateral sides of the wind wheel or at the ends of the rotational axis, a wind wheel configuration can accommodate much higher stress levels than contemporary wind turbines. Also, as shown in FIG. 1, in accordance with the present invention, the turbines mounting preferably has a low profile to take advantage of the high wind loading that occurs in these siting environments. It is a preferred component of the present invention to capture these winds with magnified velocities and their increased energy vectors.

While the lateral support structure is intended to firmly ground the system, it should be understood that the system could still be mounted in such a way as to be rotatably to accommodate a changing prevailing wind direction. Thus, a large rotatably mounted concrete base can be provided to which the later supports are therein secured. Additionally, further wind direction monitoring equipment can be configured to automatically adjust the rotational position of the system. Also, it is should be understood that the system can be coupled to an electrical power storage sub-system and appropriate power cabling for collection and/or redistribution of power between the wind turbine and the storage sub-system. The stored power could even by used to power the monitoring and rotating equipment, in order to maximize performance of the system.

Thus, in a preferred embodiment of the present invention a system and method is provided for collecting energy from a prevailing wind. The system and method include a concentrating structure having a surface substantially facing an unobstructed expanse of a terrain and/or water communicating the prevailing wind toward the surface. The surface is configured to deflect and concentrate the prevailing wind. Also, the system includes a wind turbine having a rotational axis substantially horizontal and perpendicular to the direction of the prevailing wind. The wind turbine is mounted adjacent to the structure and situated to receive the concentrated wind.

Preferably, a wind collection system is disposed at or near the edge of a cliff, steep hill, bluff or other elevated structure, overlooking an unobstructed fetch of open water. The wind collection system is preferably mounted at or near the ground toward the top of the cliff, hill or bluff, and adapted to take advantage of the concentrated winds as they deflect and rise along the face and pass over the crest of the topological obstruction. It is advantageous for the system to be positioned on a structure that is significantly larger than the wind turbine itself. It is further advantageous to have that structure be one or more orders of magnitude larger than the wind turbine.

Similarly, when wind moving horizontally encounters vertical obstructions, a concentrating effect can be generated in the horizontal direction. This funneling effect on wind can be generated by natural obstructions such as a row of hedges, trees, hills or other natural obstructions and/or manmade structures such as buildings, edifices, towers, walls, fences and other similar constructions. Optimally, such wind deflectors are situated at an angle to the oncoming wind, in the same way a funnel redirects the flow of fluids. Thus, the present invention takes advantage of groupings of natural wind deflectors such as trees, bushes and/or hills that are often found in rural and even suburban settings. Further, the present invention can take advantage of the tall buildings and/or collective structures in urban settings that can combine the wind energy forces.

The energy vector multiplication phenomenon is analogous to the example of having two 3 inch diameter bottles collecting rain water. If one bottle has a 12 inch diameter funnel on its top while the other has none, the bottle with the 12 inch diameter funnel will generally collect 16 times the amount of rain as compared to the bottle with no funnel. With regard to the present invention, the cliff face, wind fence or sloped surface are analogous to the funnel on top of the bottle in terms of gathering an increasing the total energy that passes a designated location. Thus, situating a wind wheel at the crest of a cliff or the edge of a building roof can take advantage of the energy vector multiplication. Similarly, a ground-based mounting of a wind wheel can take advantage the horizontal funneling of wind that occurs from natural or man-made wind deflectors. Alternatively, both horizontal and vertical concentrating deflectors could be employed in unison to further enhance wind speeds.

In a preferred embodiment, the wind collection apparatus should be mounted in a location that provides an unobstructed fetch of wind as it approaches. While the system can be mounted at ground level with the appropriate sighting considerations, it could also be sighted at or near the top of a sloping natural or manmade structure such as a knoll, bluff, cliff, hill or building. It is also preferred that the present wind turbine be bounded on its sides by large scale wind deflection surfaces such as topographical features, vegetation and/or manmade structures that can be set at a slight angle to the prevailing wind in order to funnel or direct those winds toward the wind collection device. Such a configuration will take advantage of the energy vector multiplication that occurs and result in the capture of significantly higher velocities of wind than that of the prevailing wind speeds. Such higher velocities are also associated with higher energies per unit area then those seen from conventional wind turbines, translating into a potential for collecting a higher concentration of energy.

A further advantage of this system is that it does not require high mounting towers which are aesthetically displeasing and also cause problems to migrating birds. Additionally, a low ground mounting and/or building mounted profile allows for easier maintenance and/or repair access. Further, the system of the present invention can take advantage of wind collection sites that have previously been ignored specifically because of their high wind and/or turbulent conditions.

While some embodiments of the present invention are specifically illustrated and/or described herein, it will be appreciated that modifications and variations of the present invention may be affected by those skilled in the art without departing from the spirit and intended scope of the invention.

What is claimed is:

1. A system for collecting energy from a prevailing wind, the system comprising:
a concentrating structure having a surface substantially facing an unobstructed expanse of at least one of a terrain and water communicating the prevailing wind toward the surface, the surface configured to deflect and concentrate the prevailing wind; and
a wind turbine having a rotational axis substantially horizontal and perpendicular to the direction of the prevailing wind, the wind turbine mounted adjacent to the structure and situated to receive the concentrated wind.

2. The system of claim 1, wherein the structure includes at least one of an artificial construct and a natural geographic feature.

3. The system of claim 1, wherein the structure is significantly larger than the wind turbine.

4. The system of claim 1, wherein the structure is larger than the wind turbine by at least one order of magnitude.

5. The system of claim 1, wherein the structure includes at least one of a bluff, cliff, knoll, hill or man-made building.

6. The system of claim 1, wherein the wind turbine is structurally supported on two lateral sides relative generally to the prevailing wind, wherein the wind turbine rotational axis terminates substantially at both lateral sides.

7. The system of claim 1, wherein the structural support cooperates to maintain the wind turbine collecting energy during gale or higher force winds.

8. The system of claim 1, wherein the rotational axis of the wind turbine is positioned perpendicular to the concentrated wind.

9. The system of claim 1, further comprising:
an electrical power storage sub-system; and
transmission cables communicating electrical power between the wind turbine and the storage sub-system.

10. The system of claim 1, further comprising:
at least one horizontal wind deflector mounted up-wind and laterally to the wind turbine relative to the prevailing wind, the horizontal wind deflector further deflecting and concentrating the prevailing wind toward the wind turbine.

11. A method of collecting wind energy, comprising:
locating a wind turbine adjacent the top edge of a structural formation, the formation including a surface extending downward from the top edge and substantially facing an unobstructed expanse of at least one of a terrain and water communicating a prevailing wind, the surface configured to redirect and concentrate the prevailing wind upward toward at least the top edge of the formation;
positioning the wind turbine to have a rotational axis disposed substantially horizontal and perpendicular to the prevailing wind and disposed to receive the concentrated wind.

12. The method according to claim 11 further comprising:
positioning at least one horizontal wind deflector up-wind and laterally to the wind turbine relative to the prevailing wind, the horizontal wind deflector further deflecting and further concentrating at least one of the prevailing wind and the concentrated wind toward the wind turbine.

13. The method according to claim 11, further comprising:
coupling an electrical power storage sub-system to the wind turbine for at least one of collection and redistribution of power between the wind turbine and the storage sub-system.

14. The method according to claim 11, wherein the wind turbine is structurally supported on two lateral sides relative generally to the prevailing wind, wherein the wind turbine rotational axis terminates substantially at both lateral sides.

15. The method according to claim 11, wherein the rotational axis of the wind turbine is positioned perpendicular to the concentrated wind.

16. A source of electrical energy produced by a process comprising:
locating a wind turbine adjacent the top edge of a structural formation, the formation including a surface extending downward from the top edge and substantially facing an unobstructed expanse of at least one of a terrain and water communicating a prevailing wind, the surface configured to redirect and concentrate the prevailing wind upward toward at least the top edge of the formation;
positioning the wind turbine to have a rotational axis disposed substantially horizontal and perpendicular to the prevailing wind and disposed to receive the concentrated wind.

17. The electrical energy source of claim 16, further comprising:
positioning at least one horizontal wind deflector up-wind and laterally to the wind turbine relative to the prevailing wind, the horizontal wind deflector further deflecting and further concentrating at least one of the prevailing wind and the concentrated wind toward the wind turbine.

18. The electrical energy source of 16, further comprising:
coupling an electrical power storage sub-system to the wind turbine for at least one of collection and redistribution of power between the wind turbine and the storage sub-system.

19. The electrical energy source of claim 16, wherein the structural formation includes at least one of an artificial construct and a natural geographic feature.

20. The electrical energy source of claim 16, wherein the wind turbine is configured to collect wind energy during gale or higher force winds.
